(19) United States
(12) Patent Application Publication
(10) Pub. No.: US 2002/0137507 A1
(43) Pub. Date: Sep. 26, 2002

(54) System and method for providing automatic multimedia messages service

(75) Inventor: Yair Winkler, Keysaria (IL)

Correspondence Address: Rosenman & Colin LLP, 575 Madison Avenue, New York, NY, 10022-2585, US

(73) Assignee: Techimage, LLP.,

(21) Appl. No.: 09/812,926

(22) Filed: Mar. 20, 2001

(51) Int. Cl. H04Q 7/20

(52) U.S. Cl. 455/426; 455/445; 455/403; 455/3.03

(57) ABSTRACT

A system and method for providing multimedia services for electronic message center over a global computer network or cellular network, enabling Users to send SMS messages including text and multimedia items. Original text messages are delivered to graphical engine application where it is processed and analyzed, based on known algorithms for text processing. Based on text analysis the engine application selects or generates multimedia items according to pre-defined rules or algorithms and User preferences. The multimedia items and text are merged into one single message, which is delivered to any designated addresses. Optionally the user may review and edit the message as he pleases.

### FIELD OF THE INVENTION

The invention relates to a method of providing multimedia service for electronic messages center, over a network, particularly global computer or cellular networks connected by common protocols.

### BACKGROUND OF THE INVENTION

For purposes of this disclosure, by the term “network” is meant include at least two communication mobile devices connected through a communication line which can be hardwired, or virtual, such as satellite, cellular or other wireless communications. Mobile device can mean a cellular phone, PC or other similar-type device capable of receiving, transmitting, and/or manipulating message data.

For purposes of this disclosure, by the term “multimedia item” is meant include all content types such as graphical images, animation, video, audio files etc,.

The so-called Short Message Service SMS) and/or UM (Unified messaging) are a point-to-point or point-to-multipoint services which enable a user to send messages to and receive text messages from other users of a communications network. The SMS attempts to deliver a message to a mobile terminal whenever the terminal is registered to the network, even when the terminal is engaged in a voice of data call. The terminal may also roam throughout the network and still be capable of sending and receiving messages. A terminal configured for SMS provides methods for the user to receive, read, write/edit, clear, send, and save messages.

The network stores messages in at least one SMS Center (SMSC), and Mobile messages are sent to the terminals from the SMSC. Various SMS protocol layers receive the messages and check their contents. If the contents are valid, and assuming that there is room for incoming text messages in the memory of the mobile station, the message is received and stored. Otherwise, the message is rejected.

Today Known services of SMS messages enable the user to send only text messages, users may include graphics image in the delivered message but they are limited to graphical image stored in their cellular device.

It is thus a prime object of the invention to avoid at least some of the limitations of the prior art and to provide a system and method of delivering SMS message including text and multimedia items providing the users with various collections of multimedia items and automatic generation of graphical message according to given text context.

### SUMMARY OF THE INVENTION

According to the present invention is suggested a method for automatically redesigning and constructing text message delivered from source user mobile device to a target user mobile device via messaging center through computerized network yielding modified message including multimedia items, said method comprising the steps of: source user sending text message to the messaging center; source user requesting to redesign request; identifying destination address of the text message by the messaging center; analyzing said message text for detecting keywords or identifying message subject or contex, or identifying message style; selecting multimedia items related to message keywords and text subject according to pre-defined rules and user preferences; merging selected multimedia items with text message; and transmitting converted message to identified destination address of the target user.

### BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein

FIG. 1 is a general schematic representation of the environment in which the present invention is practiced;

FIG. 2 is a flow-chart of delivering graphical messages according to the present invention;

FIG. 3 is a scheme illustrating the components of the graphical engine according to the present invention;

### DETAILED DESCRIPTION OF THE PREFERRED EMBODIMENTS

The embodiments of the invention described herein are implemented as logical operations in a computing network system. The logical operations of the present invention are preferably presented (1) as a sequence of computer implemented steps running on the computing network system and (2) as interconnected machine modules within the computing network system. The implementation is a matter of choice dependent on the performance requirements of the computing network system implementing the invention. Accordingly, the logical operations making up the embodiments of the invention described herein are referred to variously as operations, steps, or modules.

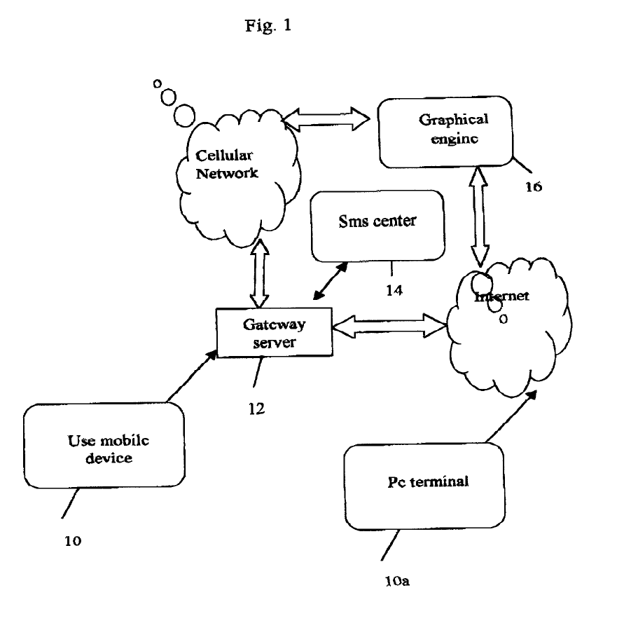

FIG. 1 illustrates the operating environment in which the present invention is used. As seen in FIG. 1 the users using mobile devices 10 or PC terminal 10a are connected to the Internet or cellular network via designated gateway 12 in the conventional manner. The users can use SMS messages service provided by SMS center 14.

Let us assume that a source user 10 desires to deliver SMS message to his friend. According to prior art the user can send only text messages, or graphical images from limited images database stored in the local memory of the user device.

According to the present invention it is suggested to provide the users with new multimedia service application 16 (“graphical engine”) located at a designated server associated with the user gateway server and/or SMS center.

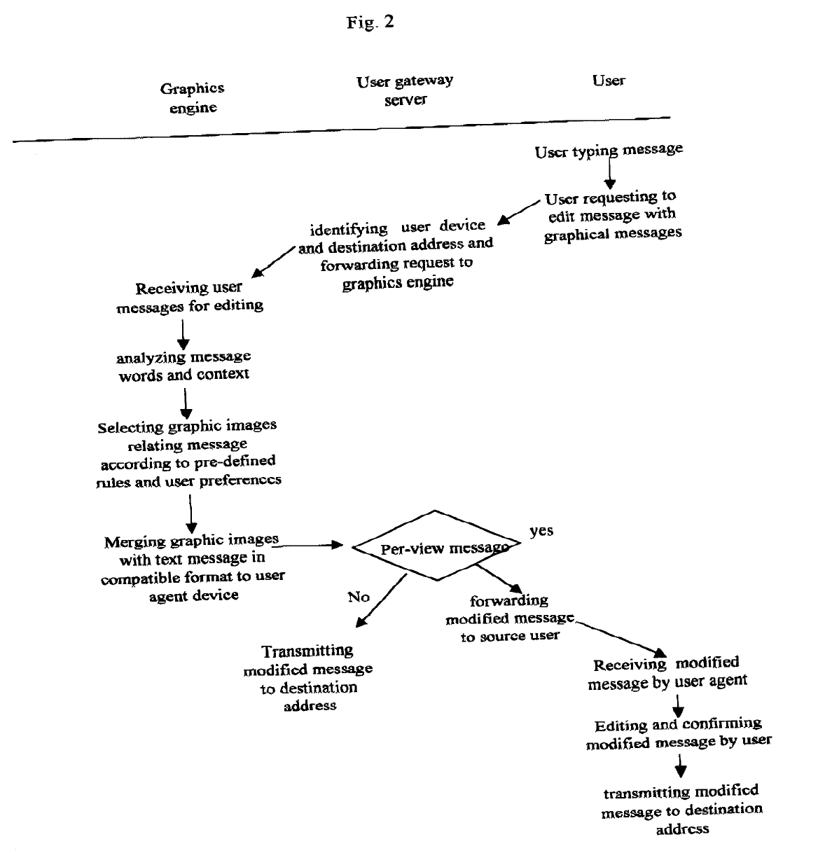

The process of delivering messages is illustrated in FIG. 2. First the originator user creates any text message, before transmitting the message the user can optionally select the multimedia service or the default service of sending the message as it is, through the SMS center.

In case the user selected the multimedia item service the message is identified by the SMS center (or optionally by the gateway service). The SMS center identifies the message destination address and optionally the device type of the originator user (“message details”).

The identified message attached with its details is transferred to the graphical engine application. The text message is processed and analyzed for identifying the keywords in the text, the text style or manner (ie. slang sarcasm, happiness) and the message text context and subject. The analysis is based on known algorithms for text processing of artificial intelligence. For example, in case of detecting “happy birthday” idiom in the text, the message subject is categorized as happy birthday message. Once the message is categorized according to one of the available subjects in the service database, the application selects the respective multimedia items such as graphical image or animation in relation to the message subject context or identified keywords. In the above example a birthday cake or a clown images may be selected. The multimedia selection is based on pre-defined rules or selection algorithm and user preferences.

The selected multimedia items are merged in the original message, creating modified message that combines the text and multimedia according to identified key words and text context. At this stage, two alternatives processes may take place. According to first option the modified message is delivered directly to the designated address, alternatively the modified message is transferred back to the originator user for preview and confirmation. The originator user views the modified message and may edit the message text or choose from selection of multimedia items provided by the graphics engine. Finally the approved message is transmitted directly to the target destination.

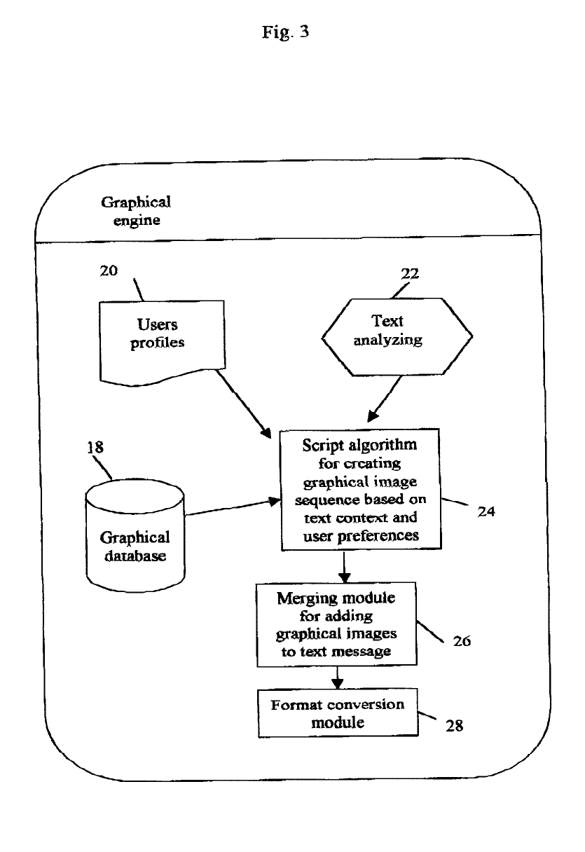

Schematic presentation of the graphic engine application is illustrated in FIG. 3. The application comprises a database of readymade multimedia items 18, wherein the items are organized according to subjects, and user profiles 20 containing users preferences.

The text analyzing module 22 receives any text message for determining text subject and or context. Module 22 is based on known text analysis algorithms e.g. identifying keywords of text and categorizing message subject accordingly. The analysis results are used by script algorithm 24 for selecting related multimedia items and organizing thereof according to text context.

The selected images are combined with the text by the merging module 26 according to the order defined by the script algorithm.

Optionally the modified message is converted into any desired format, compatible with the users identified device type by Module 28. The formatted message is transferred to the designated address or alternatively to the originator user for confirmation and/or editing.

According to further embodiment of the present invention, it is suggested to provide not only ready-made multimedia items but also automatically generated multimedia items. For implementing such additional service the graphics engine is provided with multimedia editor module. The editor module can generate original graphic images/animation/video or audio content or modify existing items according designated algorithm based on the message text and user preferences. For example, in case of greeting message the name of the user may be presented by graphic fonts, or in case of narrative message creating an animation show for illustrating the message tale.

Such services may beneficial to third parties such as sponsors for combining advertisements adapted to users messages. In case the text subject is related to sponsor product, the modified message may include commercial image as part of the multimedia items merged within the delivered message.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A method for automatically redesigning and constructing text message delivered from source user mobile device to a target user mobile device via messaging center through computerized network yielding modified message including multimedia items, said method comprising the steps of:
source user sending text message to the messaging center;
identifying destination address of the text message by the messaging center;
analyzing said message text for detecting keywords or identifying message subject or context, or identifying message style;
selecting multimedia items related to message keywords and text subject according to pre-defined rules and user preferences;
merging selected multimedia items with text message: and
transmitting converted message to identified destination address of the target user.

2. The method of claim 1 wherein multimedia items include graphical images, alphanumeric images, video and/or audio files or animation.

3. The method of claim 2 further comprising the steps of:
Identifying device type of source user by the messaging center;
converting modified message format according to identified type of user device;

4. The method of claim 2 further comprising the steps of:
transmitting the modified message to the source user before transmitting to target user;
source user review and edit modified message;
source user confirms modified message last version and sends it directly to target user.

5. The method of claim 2 further comprising the step of manipulating existing multimedia items according to the message keywords, subject context or style;

6. The method of claim 2 further comprising the step of generating multimedia items relating the message keywords and subject, context or style;

7. A modular subsystem for automatically redesigning and constructing text message delivered from source user mobile device to a target user mobile device via messaging center through computerized network yielding modified message including multimedia items, said system comprising of:
Transmitting means for forwarding text message to messaging center;
Identifying means for detecting destination address of the text message by the messaging center;
Analyzing means for detecting keywords of message, or identifying message subject or context, or identifying message style;
Selecting means for relating multimedia items to message text keywords and text subject according to pre-defined rules and user preferences;
Merging means for combining selected multimedia items with text message;
communication means for transmitting modified message to identified destination address of the target user;

8. The subsystem of claim 7 wherein multimedia items include: graphical images, alphanumeric images video and/or audio files or animation.

9. The subsystem of claim 8 further comprising of:
Identifying means for detecting device type of source user by the messaging center;
converting means for modifying message format according to identified type of user device;

10. The subsystem of claim 8 further comprising of:
transmitting means for sending the converted message to the source user before transmitting to target user;
edit means for manipulating the converted message by the source user,

11. The subsystem of claim 8 further comprising an editing means for manipulating existing multimedia items according to the message keywords, subject context or style;

12. The subsystem of claim 8 further comprising of multimedia editing tools for generating multimedia items relating the message keywords and subject, context or style;
